(19) United States
(12) Patent Application Publication
(10) Pub. No.: US 2021/0141423 A1
(43) Pub. Date: May 13, 2021

(54) CABLE RETAINERS FOR HINGE ASSEMBLIES

(71) Applicant: HEWLETT-PACKARD DEVELOPMENT COMPANY, L.P., Houston, TX (US)

(72) Inventor: Chan-Woo PARK, Houston, TX (US)

(73) Assignee: HEWLETT-PACKARD DEVELOPMENT COMPANY, L.P., Houston, TX (US)

(21) Appl. No.: 16/074,197

(22) PCT Filed: Sep. 14, 2016
(86) PCT No.: PCT/US2016/051594

§ 371 Date: Jul. 31, 2018

(51) Int. Cl. G06F 1/16; F16C 11/04; B29C 45/14

(52) U.S. Cl. CPC G06F 1/1681; B29C 45/14426; G06F 1/1683; F16C 11/04

(57) ABSTRACT

In some examples, a hinge assembly includes a hinge cover, a hinge inside the hinge cover to pivotally attach a base housing to a display housing of a computer, a space inside the hinge cover and adjacent a first side of the hinge, and a cable retainer positioned in the space, the cable retainer comprising receptacles to receive respective portions of a cable, the receptacles to retain the cable in position as the base housing and the display housing are pivoted with respect to one another with the hinge.

### BACKGROUND

Various types of computers are available to users. For portability, notebook computers or tablet computers can be carried by users wherever they go. A notebook computer has a base and a display unit that is pivotally attached to the base, such that a user can open and shut the display unit with respect to the base. In some cases, a notebook computer allows for 360° pivoting of the display unit with respect to the base. When the display unit is pivoted 360° with respect to the base, the display mounted to the display unit faces toward the user and away from the base such that the user can use the computer as a tablet computer. This type of notebook computer is also referred to as a convertible notebook computer, since it can be converted between a regular notebook computer and a tablet computer.

### BRIEF DESCRIPTION OF THE DRAWINGS

Some implementations of the present disclosure are described with respect to the following figures.

FIG. 1 is a schematic perspective view of a computer having a base housing and a display housing pivotally connected to the base housing using a hinge assembly according to some examples.

FIG. 2 is a perspective view of a portion of a hinge assembly according to some examples.

FIGS. 3-5 illustrate hinge assemblies including cable retainers for retaining cables according to various examples.

FIG. 6 is a flow diagram of a process of forming a hinge assembly, according to some examples.

### DETAILED DESCRIPTION

A computer can include a base and a display unit that are pivotally connected to one another by a hinge assembly. Such a computer can be referred to as a notebook computer, a tablet computer, or a convertible computer. A convertible computer is a computer that can be converted between use as a notebook computer and use as a tablet computer. The base and the display unit of the convertible computer can be pivoted by up to 360° with respect to one another. When pivoted the full 360° (or approximately the full 360°), a touch-sensitive display of the display unit faces away from the base, such that the user can use the convertible computer as a tablet computer by making touch inputs on the touch-sensitive display. When the display unit is rotated by less than 180° with respect to the base, the convertible computer can be used as a notebook computer.

Although reference is made to a convertible computer in some examples, it is noted that in other examples, techniques or mechanisms can be employed with respect to any computer that has a base and a display unit pivotally attached to one another using a hinge assembly. Even more generally, techniques or mechanisms according to some implementations can be applied with any computer that has a first housing and a second housing that are pivotally attached to one another by a hinge assembly.

A cable can operatively connect an electronic component in the base to an electronic component in the display unit, such that the electronic components in the base and the display unit can communicate or otherwise interact with one another. In some examples, the cable can include an electrical cable, which includes electrical wires to electrically connect components in the base and the display unit. In other examples, the cable can include an optical cable, which includes optical lines (e.g., optical fibers, optical waveguides, etc.) to optically connect components in the base and the display unit. In further examples, the cable can include a combination of electrical wires and optical lines.

The cable can extend through a space in the hinge assembly that pivotally attaches the base and the display unit of a computer. The hinge assembly includes a hinge cover and a hinge housed inside the hinge cover. A hinge can refer to a mounting component that provides a rotational axis about which further components attached to the hinge can rotate.

The space within the hinge assembly through which the cable can extend is provided inside the hinge cover. As profiles of computers have increasingly become thinner, and further as the pivoting angle of a base and display unit has increased (e.g., up to 360°), it has become more challenging to route a cable through a hinge assembly. The space available inside the hinge cover to accommodate a portion of a cable has been reduced as computers have become increasingly thinner. Also, due to the ability to pivot a base and a display unit by increasingly larger angles, the likelihood of damage to a cable that runs through a hinge assembly is increased. During testing of a computer after manufacture, the computer can be subjected to multiple cycles of pivoting of the base and display unit of the computer. Damage to the cable portion inside the hinge assembly can occur during such testing, as well as during use by a user.

FIG. 1 is a schematic perspective view of a computer 100, which can be a notebook computer or a convertible computer in some examples. The computer 100 includes a base 102 and a display unit 104, which are pivotally attached to one another using hinge assemblies 106 and 108. The base 102 has a base housing, while the display unit 104 has a display housing. A “housing” can refer to an outer structure that is to define an inner chamber in which components can be provided. A housing can refer to a single structure, or multiple structures attached together.

Although two hinge assemblies are shown in FIG. 1, it is noted that in other examples, a different number of hinge assemblies can be used, such as one hinge assembly or more than two hinge assemblies. The base 102 includes electronic components 110, and the display unit 104 includes electronic components 112. An “electronic component” can refer to any component that is electronically operational. Examples of electronic components include any or some combination of the following: a processor (e.g., a microprocessor, a microcontroller, a programmable gate array, a programmable integrated circuit device, etc.), a memory, a mass storage device, a video controller, a network controller, an input/output (I/O) device, and so forth.

As further shown in FIG. 1, in the base 102, the cable 116 has electrical and/or optical lines that connect to the electronic components 110. Similarly, in the display unit 104, electrical and/or optical lines run from the cable 116 to connect to electronic components 112.

In examples according to FIG. 1, the hinge assembly 106 includes a cable retainer 114 according to some implementations of the present disclosure, where the cable retainer 114 is to retain a cable 116 in position in the hinge assembly 106 as the base 102 and the display unit 104 are pivoted with respect to one another with the hinge assembly 106. Retaining the cable 116 in position in the hinge assembly 106 can refer to holding the cable 116 in position with respect to the hinge assembly 106 such that reduced movement of the cable 116 is exhibited as the base 102 and the display unit 104 are pivoted with respect to one another. The cable retainer 114 can be formed of any material that has a strength to hold the cable 116 in position. The cable retainer 114 can be formed of any or some combination of the following: metal, plastic, polymer, and so forth.

By using the cable retainer 114 to retain the cable 116 with respect to the hinge assembly 106, damage to the cable 116 is reduced during opening and closing of the display unit 104 with respect to the base 102, such as during normal use by a user or during cycle testing by a manufacturer or assembler of the computer 100. Cycle testing refers to repeated opening and closing of the display unit 104 with respect to the base 102.

Although FIG. 1 shows that the cable retainer 114 is provided with the hinge assembly 106, it is noted that in further examples, a cable retainer can instead or additionally be provided with the hinge assembly 108 for retaining a cable that is routed through the hinge assembly 108.

FIG. 2 is a perspective side view of the hinge assembly 106. The hinge assembly 106 includes a hinge cover 202, which can be formed of a rigid material, such as metal or some other material that can be used for housing a hinge 204 within the hinge cover 202. The hinge 204 is shown partially in dashed profile to indicate that the hinge 204 is located within the inner chamber of the hinge cover 202.

An inner space 206 (or more simply “space”) is provided within the inner chamber of the hinge cover 202 adjacent a side of the hinge 204. The space 206 is able to accommodate a portion of a cable, such as the cable 116 shown in FIG. 1, so that the cable 116 can be routed through the hinge assembly 106 by passing the cable through the space 206 between the display unit 104 and the base 102.

If a cable is loosely run through the space 206 between the base 102 and the display unit 104, then opening and closing of the display unit 104 and the base 102 can cause damage to the cable, particularly when the profile of the computer that includes the hinge assembly 106 is relatively thin and the pivoting angle of the display unit 104 with respect to the base 102 is large (such as up to 360°). In some cases, a cable can be manually inserted into the space 206, such as by personnel of a manufacturer or assembler of a computer. If not inserted properly, the likelihood of damage to the cable is increased.

In accordance with some implementations, a cable retainer can be used with a hinge assembly. FIG. 3 is a side view of the hinge assembly 106 according to some examples. In FIG. 3, the hinge cover 202 is drawn to be transparent, so that the hinge 204 and the cable retainer 304 inside the hinge cover 202 are visible.

In FIG. 3, a cable retainer 304 (which is an example of the retainer 114 of FIG. 1) can be arranged in the space 206 inside the hinge cover 202. The cable retainer 304 engages an inner wall 306 of the hinge cover 202, so that the retainer 304 fits tightly inside the hinge cover 202.

In examples according to FIG. 3, the cable retainer 304 fits entirely within the space 206 inside the hinge cover 202. In other examples, a part of the cable retainer 304 can extend outside of the space 206. Thus, in the present disclosure, a cable retainer being positioned or arranged inside the space 206 within the hinge cover 202 can refer to a cable retainer that is entirely inside the hinge cover 202, or partially inside the hinge cover 202.

In some examples, the cable retainer 304 includes receptacles 304-1 and 304-2 that receive respective cable portions 116-1 and 116-2 of the cable 116. A first cable portion 116-1 extends from the display unit 104, while a second cable portion 116-2 extends from the base 102.

In some examples, the receptacles 304-1 and 304-2 of the cable retainer 304 can include mechanical receptacles to mechanically engage the cable portions 116-1 and 116-2, respectively, within the hinge cover 202. In other examples, the receptacles 304-1 and 304-2 are electrical receptacles to electrically connect to the respective cable portions 116-1 and 116-2. More generally, a “receptacle” of a cable retainer can refer to any holder that is part of the cable retainer 304, where the holder is designed to retain a respective portion of a cable in a specified arrangement with respect to the hinge assembly.

In accordance with some implementations of the present disclosure, use of the cable retainer 114 allows for a more consistent retention of a cable with respect to the hinge assembly 106, such that the likelihood of damage of the cable during testing or use is reduced.

In examples as shown in FIG. 3, the hinge 204 is a dual-hinge that includes a first hinge portion 204-1 and a second hinge portion 204-2. The first hinge portion 204-1 has a pivoting axis 302-1 about which component (such as the display housing of the display unit 104) attached to the first hinge portion 204-1 is rotatable. The second hinge portion 204-2 has a second pivoting axis 302-2 about which a component (such as the base housing of the base 102) attached to the second hinge portion 204-2 is rotatable. The use of the dual hinge 204 with the dual pivoting axes 302-1 and 302-2 allows for larger pivoting angles between the base housing and the display housing attached to the dual hinge 204.

Although a dual hinge is shown in some examples, it is noted that in other examples, techniques or mechanisms according to some implementations can be used with a different type of hinge, such as a single hinge that pivots about just one pivoting axis.

FIG. 4 is a perspective view of the hinge assembly 106 according to further examples, which includes a cable retainer 402 (another example of the retainer 114 of FIG. 1) that is located in the space 202 adjacent the hinge 204 within the hinge cover 202. In FIG. 4, the hinge cover 202 is drawn to be transparent, so that the hinge 204 and the cable retainer 402 inside the hinge cover 202 are visible.

In examples according to FIG. 4, the cable retainer 402 is located entirely within the space 206 inside the hinge cover 202. In other examples, a portion of the cable retainer 402 can protrude from an end 402 of the hinge cover 202.

In some examples, during manufacture of the hinge assembly 106 of FIG. 4, the cable 116 (including cable portions 116-1 and 116-2) is inserted molded with the cable retainer 402. Insert molding is an injection molding process in which the material of the cable retainer 402 is injected into a mold around an insert piece (in this case the cable 116) that has been placed into the mold prior to the injection molding. The result of the insert molding is a single injection molded piece, which in this case includes the cable 116 and the hinge retainer 402. The single injection molded piece (including the cable 116 arranged in receptacles 402-1 and 402-2 of the hinge retainer 402) is then assembled inside the hinge cover 202.

In other examples, other techniques of assembling the cable 116 and the cable retainer 402 can be employed. For example, the cable 116 can be inserted into the receptacles 402-1 and 402-2 of the retainer 402. In examples shown in FIG. 4, the receptacles 402-1 and 402-2 are openings within the cable retainer 402, where one of the openings 402-1 and 402-2 is arranged above the other of the openings 402-1 and 402-2.

The cable 116 that includes the cable portions 116-1 and 116-2 passes through the openings 402-1 and 402-2 into the space 206, and once past the cable retainer 402. The cable 116 is injection molded with a bent portion 406, where the cable 116 bends to reverse direction inside the space 206. More specifically, the space 206 within the hinge cover 202 includes a first space portion 206-1 and a second space portion 206-2, both within the hinge cover 202. The cable retainer 402 fills the first space portion 206-1, and the second space portion 206-2 is provided further inside the hinge cover 202 than the cable retainer 402. The bent portion 406 of the cable 116 is provided inside the second space portion 206-2.

The bent portion 406 of the cable 116 in the second space portion 206-2 allows the cable 116 to reverse direction inside the second space portion 206-2.

FIG. 5 is a side view of the hinge assembly 106 according to yet further examples. Instead of using a mechanical cable retainer, such as the cable retainer 402 of FIG. 4, a communication connector 502 can be used as the cable retainer (which is an example of the cable retainer 114 of FIG. 1). For example, the communication connector 502 can be an electrical connector, or alternatively, can be an optical connector. The first cable portion 116-1 of the cable 116 is communicatively connected to a first port 502-1 of the communication connector 502, while the second cable portion 116-2 of the cable 116 is communicatively connected to a second port 502-2 of the communication connector 502. The ports 502-1 and 502-2 of the communication connector 502 are examples of the receptacles 304-1 and 304-2 of the cable retainer 304 shown in FIG. 3.

In examples according to FIG. 5, the end portion of the first cable portion 116-1 is connected to the communication port 502-1, and the end portion of the second cable portion 116-2 is connected to the communication port 502-2. In such implementations, the cable 116 does not extend into the hinge assembly, but rather each of the respective cable portions 116-1 and 116-2 ends at the respective port 502-1 or 502-2 of the communication connector 502.

FIG. 6 is a flow diagram of an example process of forming a hinge assembly according to some implementations. The process includes arranging (at 602) a hinge inside a hinge cover, the hinge to pivotally attach a base housing (the housing of the base 102, for example) to a display housing (the housing of the display unit 104, for example) of a computer. The process further includes positioning (at 604) a cable retainer in a space inside the hinge cover, the cable retainer including receptacles (e.g., 304-1 and 304-2 in FIGS. 3, 402-1 and 402-2 in FIGS. 4, 502-1 and 502-2 in FIG. 5) to receive respective portions of a cable, the receptacles to retain the cable in position as the base housing and the display housing are pivoted with respect to one another with the hinge.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A hinge assembly comprising:
a hinge cover;
a hinge inside the hinge cover to pivotally attach a base housing to a display housing of a computer;
a space inside the hinge cover and adjacent a first side of the hinge; and
a cable retainer positioned in the space, the cable retainer comprising receptacles to receive respective portions of a cable, the receptacles to retain the cable in position as the base housing and the display housing are pivoted with respect to one another with the hinge.

2. The hinge assembly of claim 1, wherein a first receptacle of the receptacles is to receive a first cable portion of the cable, and a second receptacle of the receptacles is to receive a second cable portion of the cable, the first cable portion extending from the base housing through the first receptacle into the space, and the second cable portion extending from the display housing through the receptacle into the space.

3. The hinge assembly of claim 1, wherein the cable is injection molded with the cable retainer.

4. The hinge assembly of claim 1, wherein the cable retainer engages an inner wall of the hinge cover.

5. The hinge assembly of claim 4, wherein the receptacles comprise a first receptacle and a second receptacle, the first receptacle arranged above the second receptacle in the cable retainer to hold respective first and second portions of the cable one above another as the base housing and the display housing are pivoted with respect to one another with the hinge.

6. The hinge assembly of claim 4, wherein the space inside the hinge cover includes a first space portion and a second space portion, wherein the cable retainer fills the first space portion inside the hinge cover, and wherein the second space portion inside the hinge cover accommodates a bent portion of the cable.

7. The hinge assembly of claim 1, wherein the cable retainer comprises a communication connector, the receptacles comprising ports of the communication connector to communicatively connect to the respective portions of the cable.

8. The hinge assembly of claim 7, wherein the communication connector comprises an electrical connector or an optical connector.

9. The hinge assembly of claim 1, wherein the hinge comprises a dual hinge to enable 360° pivoting of the base housing and display housing.

10. A computer comprising:
a display housing for a display of the computer;
a base housing for a base of the computer;
a cable extending from the display housing to the base housing; and
a hinge assembly comprising:
a hinge cover;
a hinge inside the hinge cover to pivotally attach the base housing to the display housing;
a cable retainer having a portion arranged inside the hinge cover and positioned adjacent a first side of the hinge, the cable retainer comprising a first holder to hold a first portion of a cable, and a second holder to hold a second portion of the cable, the first and second holders to retain the cable in position as the base housing and the display housing are pivoted with respect to one another with the hinge.

11. The computer of claim 10, wherein the cable extends through the cable retainer into a space inside the hinge cover, and the cable bends to reverse direction inside the space.

12. The computer of claim 10, wherein the cable retainer comprises a connector having ports communicatively connected to the first and second portions of the cable.

13. The computer of claim 10, wherein the cable is injection molded with the cable retainer.

14. A method of forming a hinge assembly, comprising:
arranging a hinge inside a hinge cover, the hinge to pivotally attach a base housing to a display housing of a computer; and
positioning a cable retainer in a space inside the hinge cover, the cable retainer comprising receptacles to receive respective portions of a cable, the receptacles to retain the cable in position as the base housing and the display housing are pivoted with respect to one another with the hinge.

15. The method of claim 14, further comprising injection molding the cable with the cable retainer.
